(19) United States
(12) Patent Application Publication
(10) Pub. No.: US 2004/0108802 A1
(43) Pub. Date: Jun. 10, 2004

(54) Deflection yoke having function for self correction of inner pin distortion

(75) Inventors: Dong Chol Shin, Suwon-Shi (KR); Gong Hee Park, Ansan-Shi (KR)

Correspondence Address: DARBY & DARBY P.C., P. O. BOX 5257, NEW YORK, NY, 10150-5257, US

(73) Assignee: Samsung Electro-Mechanics Co., Ltd., Suwon-Shi (KR)

(21) Appl. No.: 10/409,388

(22) Filed: Apr. 8, 2003

(30) Foreign Application Priority Data
Dec. 10, 2002 (KR) 2002-78423

(51) Int. Cl. H01J 29/70

(52) U.S. Cl. 313/440; 313/477 R

(57) ABSTRACT

Disclosed is a deflection yoke having function of self-correction of inner pin distortion. More than one screen sub bent of the deflection yoke are formed between the screen bent of the deflection coil and the reference line, for improving inner pin distortion of the screen. Additionally, a section part for connecting the screen bent with the screen sub bent improves inner pin distortion of the screen together with the screen sub bent. The deflection yoke having function of self-correction of inner pin distortion does not use an additional circuit for suppressing pincushion as was in the related art, thereby reducing productivity costs, reducing power dissipation as well.

### BACKGROUND OF THE INVENTION

1. Field of the Invention

The present invention relates to a technology for correcting pin distortion phenomenon generated in a CRT(Cathode Ray Tube) product and more particularly to a deflection yoke having function of self correction of inner distortion, capable of improving pincushion on the central region by providing a structure having more than one bent between a screen bent of a deflection coil and a reference line.

2. Description of the Related Art

Generally, an image on TV(Television) screen or computer monitor watched by a human being, is not a fixed image, but a continuously moving image consisting of many fixed images, represented at a rate of about thirty times per second, and color represented on the screen is a result of combination of electron beams illuminated by phosphors of red, blue, green plastered on the screen surface of a brown tube.

Namely, interlaced scanning is performed using 525 scanning lines from left upper end to right lower end during 1/30 second, so that one frame containing the whole image information, is formed. Here, intensity of the electron beam is adjusted and brightness of the screen is varied, using the property that color is illuminated much more as the electron beam strongly hits on the phosphor, whereby video signal is visualized. If the electron beam is not scanned in the foregoing manner, only one bright point is formed on the central region of the screen and image is not realized properly.

The CRT and the deflection yoke are important means for realizing image possibly recognized by human being by means of a displaying device such as the brown tube, from video signals delivered through a camera.

The CRT emits an electrical signal in form of an electron beam, having the electron beam hit on a phosphor film of a screen. Here, an excited electron from the phosphor film comes back to an original energy level, emitting light. The CRT is a display device for realizing image using such optical property.

Construction of the CRT of the related art being used generally, will be briefly described in the following.

The CRT is excellent in its displaying quality and its cost performance ratio, and is most universally used display device today in spite of an introduction of new display device such as a LCD(Liquid Crystal Display), a PDP(Plasma Display Panel).

Generally, the CRT has a deflection yoke for having the electron beams exactly reached onto the phosphor film plastered on the screen surface of the CRT by deflecting electron beams consisting of three colors discharged from an electron gun.

The deflection yoke is the most important element among magnetic devices of the CRT, playing a role of realizing an electrical signal transmitted to a time series, into an image on the screen of the CRT.

More specifically, simply the phosphor positioned only at the center of the screen is illuminated as the electron beam discharged from the electron gun goes straight on the screen due to a high voltage, therefore, the deflection yoke, located in the outside, plays a role of deflecting the electron beam so that the electron beam reaches on the screen in an order of scanning. Such deflection yoke generates magnetic field, for exactly deflecting the electron beam to the phosphor film plastered on the screen of the CRT using the property that the electron beam changes its progression direction under influence of the electromagnetic force when passing through magnetic field.

FIG. 1 is a sided view for the CRT of the related art. As shown in FIG. 1, the deflection yoke 104 is positioned in the RGB electron gun part 103 of the CRT 100, for deflecting the electron beam scanned from the electron gun 103a, to the screen surface 102 plastered with the phosphor film.

The phosphor on the phosphor film operates so that the electron energy changes into light due to collision of the electron beam. Here, selection of phosphor and plastering technology should be considered for appropriate color, continuation, and satisfactory life.

The deflection yoke 104 includes a pair of coil separators 110, vertically symmetric, and being combined to one single member. The coil separator 110 is provided to insulate a horizontal deflection coil 115 from a vertical deflection coil 116, and at the same time, to assemble positions of those coils in good order. The coil separator consists of: a screen part 111a joined to the side of the screen surface 102 of the CRT 100; a rear cover part 111b; and a neck part 112 extended integrally from the central surface of the rear cover part 111b and joined to the electron gun part 103 of the CRT 100.

The coil separator 110 having the foregoing construction, has, in its inner and outer peripheral surfaces, a horizontal deflection coil 115 and a vertical deflection coil 116 for generating horizontal deflection magnetic filed and vertical deflection magnetic field, respectively, using power source provided from the outside.

Also, a pair of ferrite cores 114 made of magnetic material is provided to enclose the vertical deflection coil 116, for strengthening magnetic field generated from the vertical deflection coil 116.

The rear cover part 111b of the coil separator 110 has a printed circuit board p in its one side, for controlling(e.g. supplying power source to the horizontal and vertical deflection coils 115 and 116) electrical signal for the deflection yoke through many circuit elements mounted.

When saw tooth wave currents of different frequencies are applied to the horizontal and vertical deflection coils 115 and 116, then the horizontal deflection coil 115 generates magnetic field line in vertical direction by Fleming's left hand rule so that force is given to the electron beam in horizontal direction, while the vertical deflection coil 116 generates magnetic field line in horizontal direction by the same rule so that force is given to the electro beam in vertical direction. Therefore, three color-electron beams consisting of red R, green G, blue B discharged from the electron gun 113a, are deflected as much as a predetermined angle, respectively, whereby scanning position on the screen is determined.

In the meantime, the deflection yoke as shown in FIG. 1 is roughly classified into a Saddle-Saddle type shown in FIG. 2 and FIG. 3 depending on a wiring structure, and a Saddle-Toroidal type(not shown in the picture) whose wiring structure is more or less different from the Saddle-Saddle type.

The deflection yoke of the Saddle-Saddle type as shown in FIG. 2 and FIG. 3, is configured such that a horizontal deflection coil 115 of a Saddle type is mounted on up and down portions in the inner peripheral surface of the screen part of the coil separator having an approximately cylindrical shape, and a vertical deflection coil 116 of a Saddle type is mounted on right and left portions in the outer peripheral surface of the screen part. Also, a ferrite core 114 of an approximately cylindrical shape is mounted on the outer peripheral surface of the screen part 111a of the coil separator 110, for strengthening magnetic field of the vertical deflection coil 116.

Furthermore, a coma free coil(not shown) for correcting COMA generated by the vertical deflection coil 116, is mounted on the vicinity of the outer periphery of a neck part 112 of the coil separator 110.

The deflection yoke of the Saddle-Toroidal type is configured such that a horizontal deflection coil 115 of the Saddle type is mounted on up and down portions in the inner peripheral surface of the screen part of the coil separator 110 having an approximately cylindrical shape, and a ferrite core 114 of an approximately cylindrical shape is provided in the outer periphery of the screen part, and a vertical deflection coil 116 of a Toroidal type is wired along up and down portions of the ferrite core 114.

Also, a coma free coil(not shown) for correcting COMA generated by the vertical deflection coil 116, is provided in the vicinity of the outer periphery of the neck part 112 of the coil separator 110.

The rear cover part 111b of the coil separator 110 has a printed circuit board p in its one side, for controlling(e.g. supplying power source to the horizontal and vertical deflection coils 115 and 116) electrical signal for the deflection yoke through many circuit elements mounted.

The CRT having the foregoing construction starts to compete against the LCD and the PDP which are flat display devices, due to the recent trend of continued light weight and flatness for the display device in the display market.

The LCD and the PDP display devices currently playing an important role in the display device together with the CRT, will be briefly described in the following.

The monitors for use in desktop application are roughly classified into the CRT monitor and the TFT(Thin Film Transistor) LCD, and as the monitor gets bigger and bigger the CRT monitor shows much restrictions in space, so that demand for the LCD monitor is increasing gradually.

In early 1970s, the LCD began to be used for an electronic calculator of a segment type, and a display part of a watch, and was applied to an electronic organizer and is currently being used and applied to products including a PC(Personal Computer), a liquid crystal color television, car navigation system, etc.

In an early stage, the LCD did not show a very good performance in an aspect of display compared to the CRT, but recently TFT LCD has been developed, so that high contrast, wide angle of vision range, high resolution, rapid response are possibly obtained, and as a result of development of such TFT LCD, color image and moving picture image are possibly provided.

For display performances required for display device, there exist high contrast ratio, high brightness, high resolution, displaying property, rapid response performance, wide angel of vision range, etc. Though the simple matrix structure of the LCD of the related art could provide image information such as a character, a diagram, such simple matrix structure has a problem that property relations for those image information are conflicting each other. Namely, if one property gets better, then other property gets worse, so that achieving high performance on the whole was unreasonable. Particularly, a problem of cross talk was generated.

In order to resolve such problems, the TFT LCD of active matrix structure, capable of improving displaying performance by adding switching element to each pixel, has been developed.

Operation principle of the TFT LCD will be described in the following, in which: liquid crystal, which is interim material between solid and liquid, is provided to between two shallow glass plates, and voltage difference between electrodes installed on the up and down glass plates, changes arrangement of liquid crystal molecules, whereby light and shade is generated, through which image is displayed. Namely, the TFT LCD is a display device using a kind of optical switching phenomenon.

The liquid crystal is a kind of organic compounds called thermotronic liquid crystal which is liquid in an aspect of appearance but anisotropic crystal in an aspect of optics, becoming liquid under condition of a predetermined temperature range.

In order to induce direction of liquid crystal, paths for arranging the liquid crystal in a constant direction at an alignment layer, which is a shallow organic layer consisting of polimide, are formed, and if the liquid crystal comes into contact with a surface of the alignment layer, then the liquid crystal molecules are arranged in parallel with the alignment paths. The alignment layers respectively installed on both sides are arranged so that the layers are twisted, crossing each other as much as 90 degree in their directions and the liquid crystal molecules are also continuously twisted up to 90 degree in their arrangement directions, and incident light progresses along the liquid crystal molecules.

When signal voltage or force from the outside is applied to the liquid crystal using the TFT, the direction of the liquid crystal is released from the state of being 90 degree-twisted, and is vertically aligned in one direction, so that light goes straight on. Whether incident light passes through or not, is determined by twisting and releasing of the liquid crystal, and when light passing through the liquid crystal is concentrated in one direction by attaching a polarizer to the glass plates on both the sides and is provided to a pixel, an image is realized on the screen finally. Additionally, a RGB color filter is arranged so that the screen operates as a color screen, and a color signal is applied to each filter in order to control brightness.

More detailed description of the TFT LCD will be omitted, for the description would be obvious to a person having ordinary skill in the art.

The PDP, which is a kind of flat display device, is a display device using gas discharge. The name ‘plasma’ has been put because a gas generated from the discharge is plasma.

Operation of the PDP will be described in the following, in which: plasma(mixture of neon and xenon gases) is inserted between two closed glass plates on the surface of which parallel electrode rods are mounted, where the glass plates are completely closed and the electrode rods form exact angle, thereby making a pixel. At the moment, when voltage pulse passes through between the two electrode rods, the inserted gas brings about chemical reaction, changing into lightly ionized plasma state emitting UV(ultraviolet) radiation. The emitted UV radiation activates color phosphor, and visible light is generated from each pixel, and necessary image is realized by combination of such lights.

Vivid display is possibly achieved by the PDP, so that the PDP was used for factory automation or apparatus such as a vending machine, a gas gauge in early stage. But recently, as trend of small sizing, light weight, and high performance in display device is pursued, the PDP is now being used for electronic apparatus for office automation including the PC.

The PDP is excellent in its display quality, fast in its response speed, superior in an aspect of reliability, so that the PDP is also being used for the display device of laptop computer. Furthermore, the PDP of 40 inches could be realized in thin type whose thickness is less than 10 cm, showing excellent properties in aspects of space saving and design.

Also, as being a display of a phosphor illuminating type compared to a projection TV, the PDP is superior in realization of vivid image and natural color, and shows small difference in its image quality for the central part and circumferential part, representing strong point in processing multimedia information. But driving voltage is high so that much cost is consumed for manufacturing of a driving unit, and power is also dissipated much.

More detailed description of the PDP will be omitted, for the description thereof would be obvious to a person having ordinary skill in the art.

In the following, performance of the LCD and the CRT which are primary display devices, will be briefly compared on the basis of facts generally known to a person having ordinary skill in the art.

On the whole, for inferior characteristics of the LCD compared to the CRT, there exist angle of vision range, a number of display colors, response speed, and for superior characteristics of the LCD compared to the CRT, there exist power dissipation, electromagnetic wave, light weight, size(space saving), image quality(focus, GD(geometric distortion), CG(convergence)). For similar or equivalent display characteristics, there exist maximum brightness, contrast, flicker.

Regarding angle of vision range, though the LCD shows no big problem in watching from 120 degree in horizontal range, and 110 degree in vertical range, but shows characteristics that color is changed depending on angle of vision range in case that many persons watch one monitor or sight of a user is a little changed to right and left or up and down. Particularly, as the size of the LCD gets bigger, the angel of the vision range should be wider, and technical improvement is required even more for the case of a large sized LCD.

Regarding the response speed, the LCD has a weak point that the response speed is slow due to molecular characteristics of the liquid crystal. Generally, the response speed does not matter much in case of word processing job or watching moving picture not fast. But, in case that an image of high speed from movie or game is played, on and off time of the liquid crystal is short and image quality gets deteriorated.

In the meantime, in case that other image would be displayed after specific fixed image is driven for a long time, the previous image pattern may be lingering. Such phenomenon is called ‘after-image’, and the LCD has a problem that the after-image is long compared to the CRT.

Regarding a number of describable colors, as using an analog signal, the CRT could support almost all the possible colors as far as a graphic card supports, but the LCD are inferior in its describable colors to the CRT.

Regarding power dissipation, the TFT LCD adopted for a notebook computer has strong points that power dissipation is small due to consideration of the characteristics such as mobility and stand by-time period(available time period at one time of charging), and power dissipation is small on the whole compared to the CRT.

Regarding electromagnetic wave, as the CRT generates considerable high frequency wave compared to the LCD, so that the CRT has a possibility of doing harm to the human body or causing malfunction of electronic machinery and equipment precisely controlled and operated. Therefore, the LCD monitor free of influence of the electromagnetic wave is widely used in a hospital, a research institute, etc. where medical devices or a variety of precision equipments are used.

Regarding weight and size, the LCD is considerably light in its weight and small in its volume compared to the CRT, so that the LCD is useful from aspects of space applicability and convenience in mobility.

Regarding image quality, the CRT has unclear pixel concept and physically scans the electron beam using the deflection yoke, so that deviation in focus, convergence, and geometrical distortion, could be generated among product models. But the LCD has resolved brightness, contrast raised as problems in an early stage, and position for each pixel of the LCD is fixed, so that focus, convergence, and geometrical distortion are exactly well balanced, showing little deviation among products. But, image quality could be deteriorated due to pixel missing phenomenon due to disorder of the TFT, which is an optical switching element for each pixel.

Regarding surface processing, reflection preventing process and static electricity preventing process are generally applied for the CRT. For the processing method, there exist coating method and thin film plastering method. The coating is difficult to perform uniformly for the flat type display device, but uniform processing of the whole screen could be performed through the film. Recently, reflection preventing process and static electricity preventing process are performed by adopting a multi-layer film. In case of the LCD, anti-glare process is performed for reflection preventing process. The anti-glare process gets the surface not to glitter.

Regarding surface strength, the surface of the CRT is made of thick glass, and is strong to external impulse, while the surface of the LCD is made of shallow polarizer, and may be damaged by shape material. Further, if given strong impulse, the LCD could be broken into pieces. Therefore, hard coating is performed separately for protection of the surface of the LCD.

As described in the foregoing, the role played in the display market by the CRT display adopting the CRT of the related art, is getting reduced due to superior display properties and rapid growth in development of the LCD and the PDP, as the trend of light weight and flatness in the display device is pursued.

Therefore, in order for the CRT product to compete with the LCD and the PDP where flat display is available, the CRT product should also be flat. Such flat type CRT adopts the method, wherein the deflection yoke deflects the electron beam emitted from the electron gun using electromagnetic force by generating a predetermined magnetic field. Therefore, in case of the flat type CRT, geometric distortion and miss convergence are apt to be generated even more compared to the CRT having curvature of the related art, and the LCD and the PDP which are flat display devices.

The geometric distortion and the miss convergence generated mainly in the CRT, will be briefly described.

In the deflection yoke of the Saddle-Saddle type or Saddle-Toroidal type, the magnetic field generated from both sides of the deflection coil oppositely positioned, shows difference depending on distribution characteristics of the vertical and horizontal deflection coils and variations in relative current amount.

In that case, the electron beam consisting of three colors initially emitted from the neck part of the coil separator, i.e., the neck part integrally extended from the rear cover part and joined to the electron gun part of the CRT, has different properties in its vector trajectory due to position of each electron gun responsible for red, green, blue, and difference in magnetic field generated from the deflection coil, whereby miss convergence is generated on the screen.

In order for the image to be realized in the color monitor or brown tube, the electron beams coming from electron guns of red, green, blue positioned in the inside of CRT, should be precisely focused at one point simultaneously. Here, in case that red color and blue color get apart from the focus with respect to the reference of green color in the center, miss convergence represents the degree of being apart.

Once the miss convergence is generated, the character or picture is shown to be overlapped on the screen and unclear. The miss convergence gets worse at the peripheral region than the central region of the screen due to structural characteristics of the CRT.

Generally, for miss convergence represented on the screen, there exist landing error, distortion error, VCR(Vertical Center Raster) distortion, HCR, YV, YH, CV, PQH.

The landing error stands for the miss convergence such that the electron beams(R, G, B) coming from the electron guns are not precisely scanned to each pixel on the screen, but scanned with being inclined to the central region or the edge region of the screen from each pixel, meaning the miss convergence at the state of getting narrow or wide.

Also, the distortion error stands for the miss convergence at the state such that the manner the electron beams(B, G, R) are scanned on the screen, is apart from up and down sides of the screen, or is concentrated on the central region of the screen, so that the beams are not scanned on the edge region, meaning the miss convergence at the state of being barrel or pin.

The HCR(Horizontal Center Raster), as shown in FIG. 4, stands for the miss convergence such that the red beam(R) and the blue beam(B) are precisely scanned on the screen, while the green beam(G) is not precisely scanned at each pixel on the screen and error is generated in horizontal direction, whereby the green beam is positioned in the inside or outside of the red beam(R) and the blue beam(B), which forms horizontal unbalance. In case of HCR distortion, a balance coil(BC) is additionally installed to move the core of the balance coil lest inductance difference of the horizontal deflection coil installed mainly in the upper and lower sides, should be generated, whereby matching and control of the inductance of the up and down horizontal deflection coil, are achieved.

The VCR(Vertical Center Raster), as shown in FIG. 5, stands for the miss convergence such that when white line is displayed in horizontal direction along the upper and lower region of the screen, the red beam(R) and the blue beam(B) are precisely scanned on the screen and matched while the green beam(G) is not precisely scanned at each pixel on the screen, whereby error is generated in vertical direction. The VCR distortion is remarkably represented at the vicinity of the upper and lower region of the screen, while there is no change in the central region.

The coma free plays a role of making characteristics of the vertical center raster, i.e., sensitivities for the center of the red beam(R) and blue beam(B) in the measurement point on the vertical axis of the CRT and the miss convergence in the vertical direction for the green beam(G), well balanced. More specifically, pin magnetic field generated from the coma free cancels the barrel magnetic field generated from the vertical deflection coil, making the green beam(G) matched with the red beam(R) and the blue beam(B).

Also, CV stands for the miss convergence such that the red beam(R) and the blue beam(B) are scanned, with being crossed each other to the vertical direction from corner region of the screen, and YV, as shown in FIG. 6, stands for the vertical miss convergence such that horizontal line of the red beam(R) is deviated from the horizontal line of the blue beam(B) at the upper and the lower regions of Y axis under assumption that the screen is divided into X axis and Y axis. In that case, variable resistance is connected and installed at the vertical deflection coil on right and left sides, and relative intensity of the current flowing to the right and left sides of the vertical deflection coil, is controlled through adjustment of the variable resistance.

In the meantime, YH, as shown in FIG. 7, stands for the miss convergence such that the vertical line of the red beam(R) and the vertical line of the blue beam(B) are crossed each other, forming axis characteristics on the screen. Namely, YH represents the degree that the vertical line of the blue beam(B) is deviated from the red beam(R), which is the reference line, at the upper and the lower ends of the center on the screen, in which minus(−) is marked for the case that the vertical line of the blue beam(B) is deviated to the left from the red beam(R) while plus(+) is marked for the case that the vertical line of the blue beam(B) is deviated to the right from the red beam(R).

In the following, geometrical distortion(GD) of the CRT will be described. GD, as shown in FIG. 8 and FIG. 9, represents distorted state of the screen, not normal state.

Particularly, due to trend of flatness in the CRT, NS distortion and pin plus(+) phenomenon are generated. As illustrated in the analysis view of the magnetic field in the horizontal direction shown in FIG. 11, the magnetic fields of the upper and the lower regions on Y axis are wrapped to the outside, and PQH becomes minus(−) as shown in FIG. 11, and resultantly, the red beam(R) and the blue beam(B) get wider diagonally with respect to Y axis. FIG. 12 shows that NS distortion is getting plus(+) according to magnetic filed characteristics as shown in FIG. 11.

FIG. 13 through FIG. 15 show miss convergence and distortion according to magnetic field analysis for the vertical direction, in which FIG. 13, FIG. 14, FIG. 15, show the magnetic field for the vertical direction, the miss convergence, the distortion, respectively.

In the meantime, recently the research and development department for the CRT, is making much efforts to improve flatness characteristics of the CRT through reduction of the geometric distortion and miss convergence in order to meet the demand of the display market.

As a representative method for correcting pin distortion among many kinds of miss convergences, the method for changing inductance value(L) upon up and down deflection using a pair of bias magnets for applying a fixed bias to a pair of drum cores wired by a horizontal correcting coil, and a variable bias coil wired by a vertical correcting coil, has been used.

The foregoing method of the related art is disclosed in Japanese patent publication No.11-261839. In the following, the method for correcting pin distortion of the related art will be described with reference to the drawing attached to the Japanese patent publication No.11-261839.

FIG. 16 is a circuit diagram showing an apparatus for correcting inner pin distortion of the related art, and FIG. 17 is a sided view showing a structure for crucial portion of a reactor for correcting inner pin distortion used for an apparatus for correcting inner pin distortion of the related art

As shown in the above FIGS., the apparatus for correcting inner pin distortion of the related art is configured such that a reactor 1 for correcting inner pin distortion including: two horizontal correcting coils L1 and L2 connected in series; one single vertical correcting coil L3; a pair of magnets 2 and 3 for applying a bias magnetic field to the horizontal correcting coils L1 and L2 and the vertical correcting coil L3, is provided, and the horizontal correcting coils L1 and L2 are connected with the horizontal deflection circuit, so that the vertical correcting coil is modulated by the period of the vertical deflection current and bias magnetic field is generated in opposite direction, whereby impedance of the horizontal correcting coil is changed and inner pin distortions at right and left on the screen are corrected.

Also, as shown in FIG. 17, the reactor 1 for correcting inner pin distortion has three correcting coils such as the first horizontal correcting coil L1 wound on the first core 4, the second horizontal correcting coil L2 wound on the second core 5, and the vertical correcting coil L3 wound on the third core 6.

Also, a pair of magnets 2 and 3 are arranged on both sides of the three cores 4 through 6, respectively, where one end of the magnet is S pole and the other end of the magnet is N pole.

Therefore, the directions of the wiring for the two horizontal correcting coils L1 and L2 are configured such that their magnetic fields are generated in reverse directions, respectively. In the meantime, the direction of the wiring for the vertical correcting coil L3 is configured such that the magnetic field(bias magnetic field) generated by a pair of the magnets 2 and 3 is opposite in its direction.

The reactor 1 for correcting inner pin distortion has the foregoing construction, and the apparatus for correcting distortion of the screen according to the related art, corrects pin distortion generated at right and left on the screen using such reactor 1 for correcting inner pin distortion.

The procedure for correcting pin distortion using a related art having the foregoing construction, will be described with reference to FIG. 17 and FIG. 18 in the following.

In FIG. 18, when pin distortions depicted as thin dotted lines at the regions of the second point P2 and the fourth point P4, is generated, the magnetic field of the horizontal correcting coils L1 and L2 is generated by the current flowing in the horizontal deflection circuit, so that the inductance value L retained by a pair of the existing horizontal correcting coils L1 and L2 get reduced due to fixed bias magnetic field of the permanent magnets 2 and 3.

In addition, the variable bias generated from the vertical correcting coil L3, cancels the magnetic field of the permanent magnets 2 and 3 in opposite direction, whereby difference in inductance values for up and down is generated and the pin distortions for the regions of P2 and P4 are corrected(the portions denoted by the thin dotted lines disappear) by size difference for up and down.

But, for the method for correcting pin distortion of the related art as described above, each of the horizontal correcting coils and the vertical correcting coil should be wired on a plurality of the cores, so that productivity is lowered, and there exist problems that distribution and characteristics of the inner pin are unstable as distribution generation gets large due to wiring of the coils and unnecessary power dissipation gets increased as the correcting circuit is additionally mounted.

Namely, in FIG. 17, elements of each core generate repulsive force by the electromagnetic force of their own, so that gap is generated and corresponding power dissipation causes the foregoing problems.

### SUMMARY OF THE INVENTION

To solve the above-indicated problems, it is, therefore, an object of the present invention to provide a deflection yoke having function of self correction of inner pin distortion, capable of improving pincushion on the central region by providing a structure having more than one bent between a screen bent of a deflection coil and a reference line.

The foregoing and other objects and advantages are realized by providing a deflection yoke having function of self correction of inner pin distortion, including: a coil separator on which a printed circuit board is positioned; deflection coils mounted on inner and outer peripheries of the coil separator, respectively, and divided into a neck part, a screen bent part, and an extension part connecting the neck part and the screen bent part, for deflecting an electron beam of the CRT by generating a predetermined magnetic field; a ferrite core mounted on an outer periphery of the coil separator, for strengthening the magnetic field of the deflection coils; more than one screen sub bent formed between the screen bent of the deflection coil and a reference line of the deflection yoke, for improving inner pin distortion of the screen.

It is an additional characteristics of the deflection yoke having function of self correction of inner pin distortion according to the present invention, that there exists a contact surface of the screen sub bent and the screen bent.

The foregoing and other objects and advantages are realized by providing a deflection yoke having function of self correction of inner pin distortion, including: a coil separator on which a printed circuit board; deflection coils mounted on inner and outer peripheries of the coil separator, respectively, and divided into a neck part, a screen bent part, and an extension part connecting the neck part and the screen bent part, for deflecting an electron beam of the CRT by generating a predetermined magnetic field; a ferrite core mounted on an outer periphery of the coil separator, for strengthening the magnetic field of the deflection coils; more than one screen sub bent formed between the screen bent of the deflection coil and a reference line of the deflection yoke, for improving inner pin distortion of the screen; and a section part symmetrically formed by connection of the screen sub bent and the screen bent of the deflection coil, for improving inner pin distortion of the screen together with the screen sub bent.

It is an additional characteristics of the deflection yoke having function of self correction of correcting inner pin distortion according to the present invention, that there exists a contact surface of the screen sub bent and the screen bent.

### BRIEF DESCRIPTION OF THE DRAWINGS

The above objects, features and advantages of the present invention will become more apparent from the following detailed description when taken in conjunction with the accompanying drawings, in which:

FIG. 1 is a sided view of a CRT(Cathode Ray Tube) of the related art;

FIG. 2 is a top, cross-sectional view of a Saddle-Saddle type deflection yoke of the related art;

FIG. 3 is a plan, cross-sectional view of FIG. 2;

FIG. 4 through FIG. 15 are exemplary views of miss convergences and geometric distortion patterns in the deflection yoke according to the related art;

FIG. 16 is an exemplary circuit diagram of an apparatus for correcting inner pin distortion of the related art;

FIG. 17 is an exemplary sided view for a crucial part construction of the reactor for correcting inner pin distortion used for an apparatus for correcting inner pin distortion of the related art;

FIG. 18 is an exemplary view of a screen upon correction of the inner pin distortion according to the related art;

FIG. 19 is a perspective view of a vertical deflection coil according the related art;

FIG. 20 is a perspective view of a crucial part of the vertical deflection coil of the related art;

FIG. 21 is a partial, perspective view of a vertical deflection coil for which a method for correcting inner pin distortion according to the present invention would be applied;

FIG. 22 is an exemplary view explaining screen region influenced by magnetic field of the deflection coil realized in FIG. 21;

FIG. 23 is an exemplary view showing the degree of inner pin phenomenon in case that the elements denoted by reference numerals 10A and 13A among elements of the deflection coil realized in FIG. 21, are missing, i.e., in case of the related art;

FIG. 24 is an exemplary view showing the degree of inner pin phenomenon generated in case that the deflection coil realized in FIG. 21 is applied; and

FIG. 25 is a graph showing experimental measurement results for difference in degrees shown in FIG. 23 and FIG. 24.

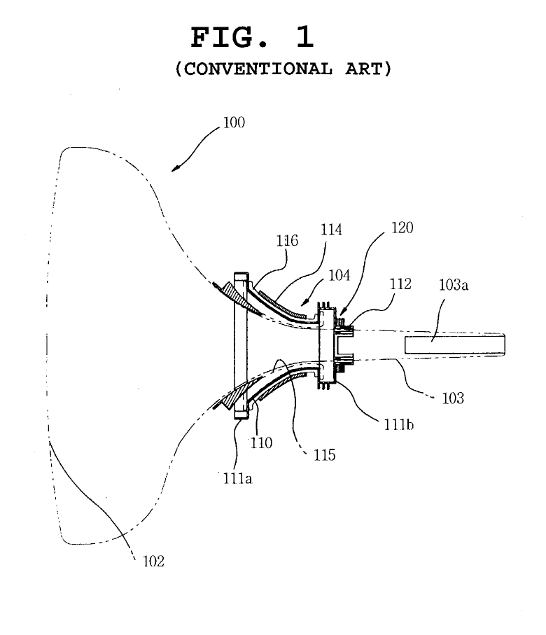

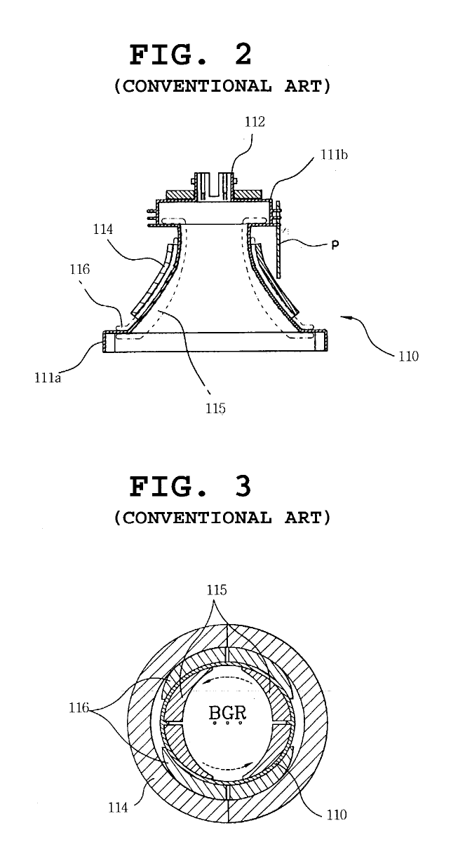

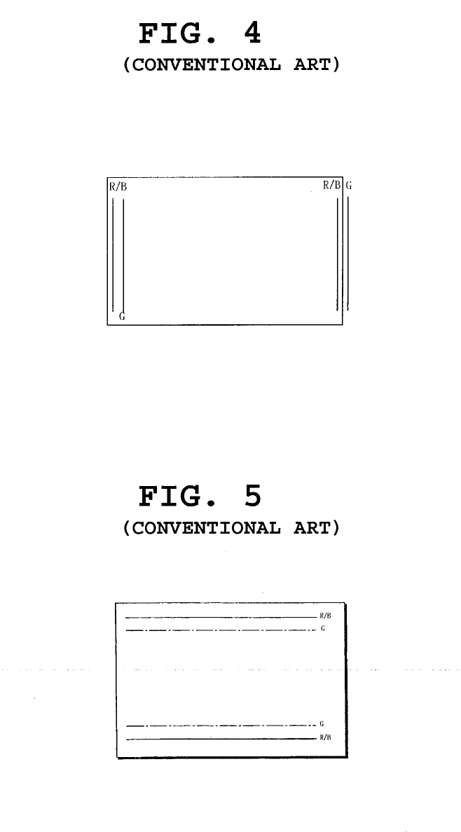

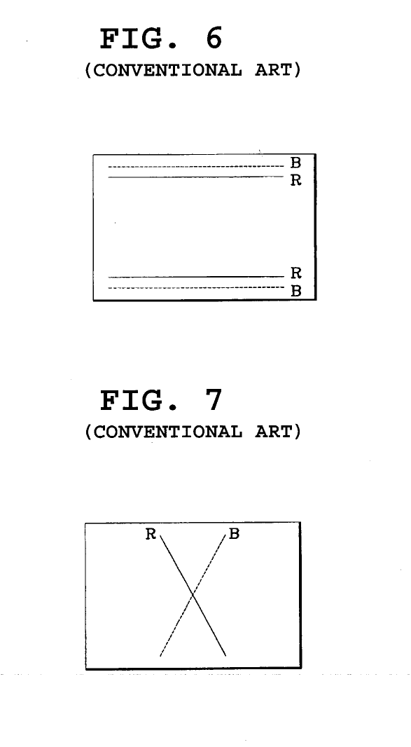

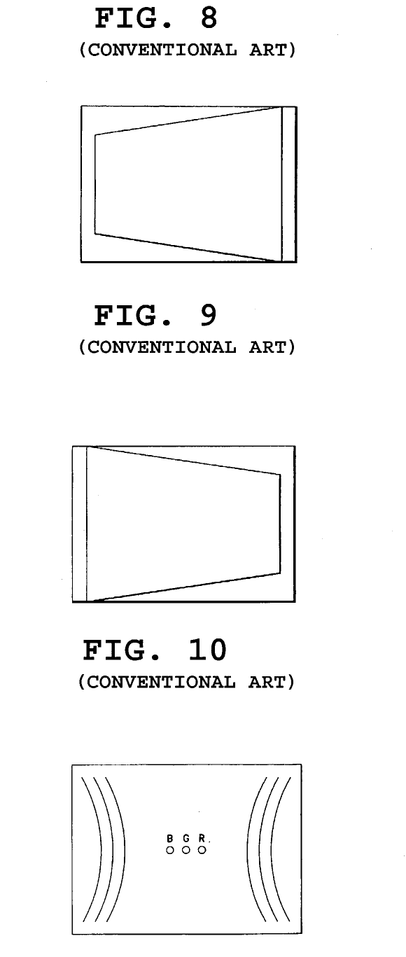

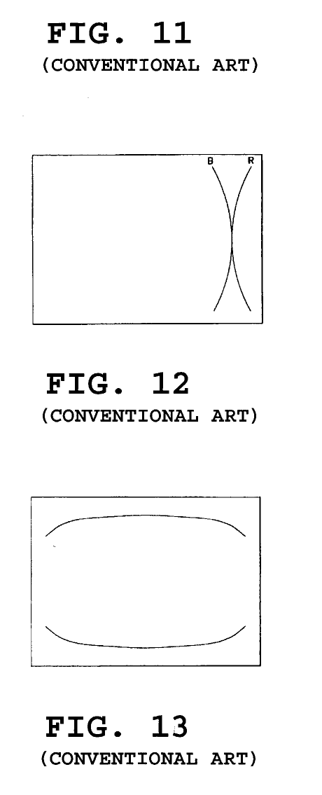

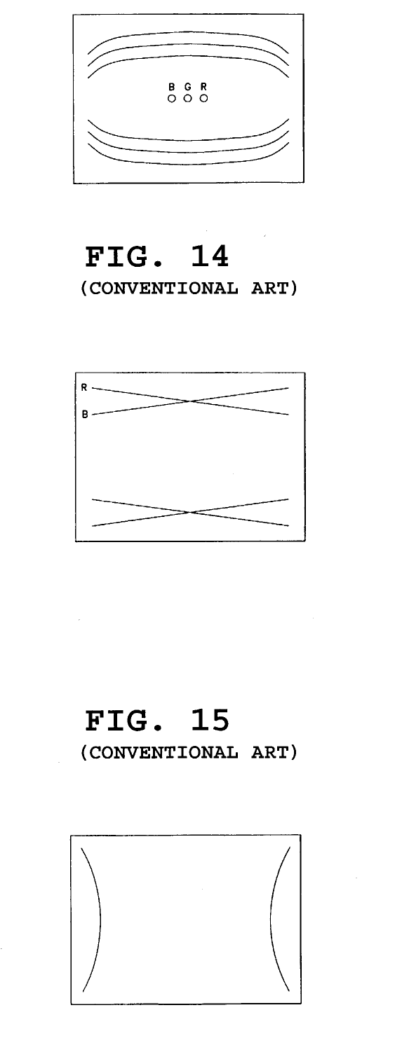

### DETAILED DESCRIPTION OF THE PREFERRED EMBODIMENT

A preferred embodiment of the present invention will now be described with reference to the accompanying drawings.

In the following description, same drawing reference numerals are used for the same elements even in different drawings.

First of all, technical thought adopted in the present invention will be briefly described in the following. The deflection yoke has a pair of coil separators made vertically symmetric and being combined to one single member. Here, the coil separator is provided to insulate the horizontal deflection coil from the vertical deflection coil, and at the same time, to assemble positions of those coils in good order. The coil separator consists of: a screen part joined to the side of the screen surface of the CRT; a rear cover part; and a neck part extended integrally from the central surface of the rear cover part and joined to the electron gun part of the CRT.

The coil separator having the foregoing construction, has, in its inner and outer peripheral surfaces, a horizontal deflection coil and a vertical deflection coil for generating horizontal deflection magnetic filed and vertical deflection magnetic field, respectively, using power source provided from the outside. Also, a pair of ferrite cores made of magnetic material is provided to enclose the vertical deflection coil, for strengthening magnetic field generated from the vertical deflection coil.

Also, a printed circuit board on which a circuit for correcting miss convergence is mounted, is installed on one side of the rear cover part of the deflection yoke.

FIG. 19 is a perspective view for a crucial part of the vertical deflection coil according the related art. As shown in FIG. 19, the vertical deflection coil is divided into a neck part 11, a screen bent part 10, and an extension part 13 connecting the neck part 11 and the screen bent part 10. Also, a window denoted by a reference numeral 12 is provided to the deflection coil.

At the moment, the portion for substantially generating deflection force is the extension part 13. Namely, when saw tooth wave of a predetermined frequency is applied to the vertical deflection coil, magnetic field is generated in the neighborhood of the extension part 13, whereby the electron beam emitted from the electron gun is deflected in the vertical direction and light point on the screen is scanned in the vertical direction.

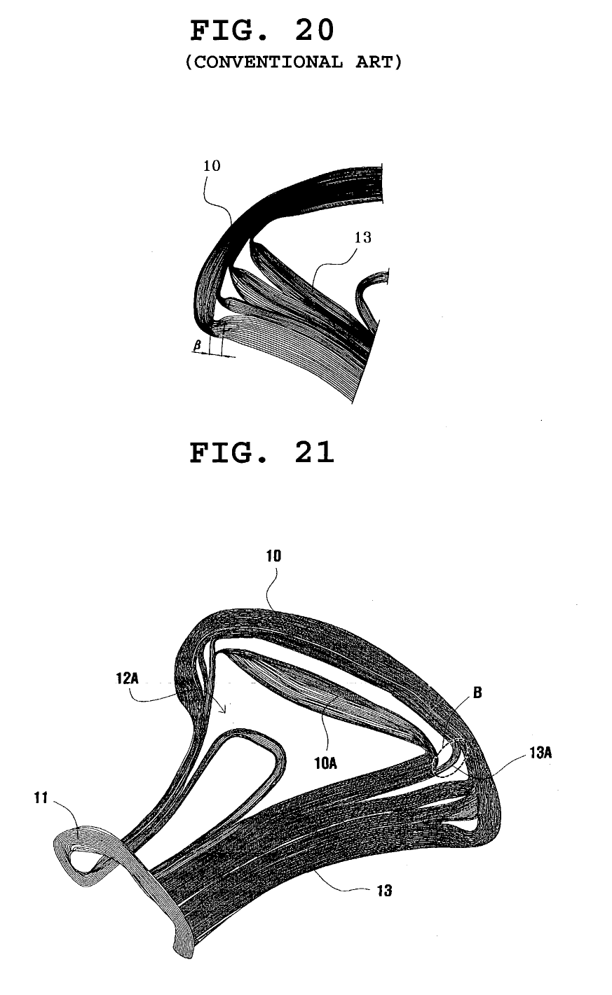

It is preferable that deflection force should be maintained uniformly in order to achieve display characteristics of high quality. Therefore, the length of the extension part 13 from the neck part 11 to the screen bent part 10, is uniformly maintained so that uniform deflection force is generated, and an uniform interval whose slope angle is changed as shown in FIG. 20 and denoted by a reference numeral β is provided to the final portion where the extension part 13 is connected with the screen bent part 10.

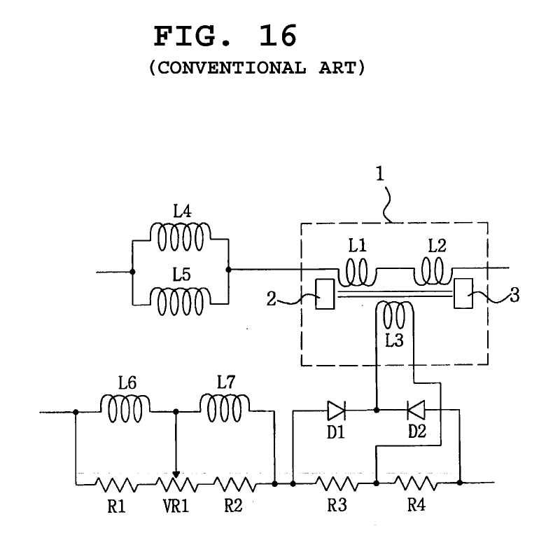

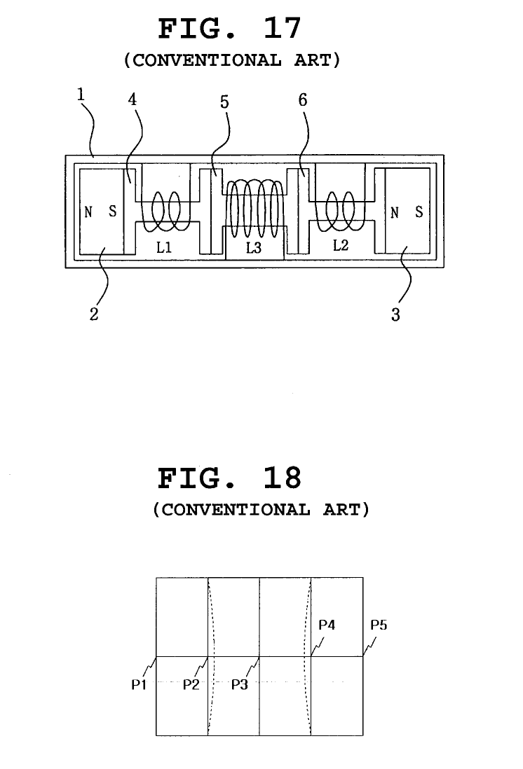

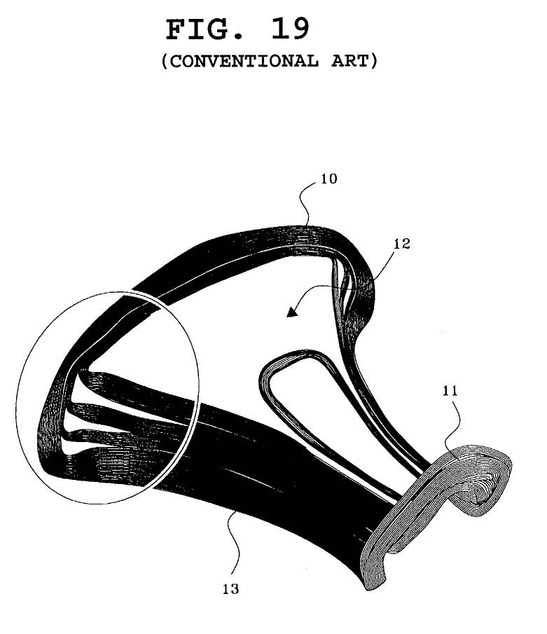

In case that such vertical deflection coil of the related art is applied, the circuit for improving inner pin distortion of the related art described with reference to FIG. 16 through FIG. 18, is indispensably required.

Therefore, the present invention is for eliminating the circuit for improving inner pin of the related art, and for suppressing inner pin phenomenon by changing the deflection coil provided to the deflection yoke.

The attached FIG. 21 is a partial, perspective view of a vertical deflection coil for which a method for correcting inner pin distortion according to the present invention would be applied.

As shown in FIG. 21, the deflection yoke having function of self correction of inner pin distortion, improves pincushion on the central region by providing a structure having more than one bent between a screen bent and a reference line.

Referring to FIG. 21, construction of the improved deflection coil mounted on the deflection yoke having function of self correction of inner pin distortion, will be described in the following. The deflection coil is configured such that a screen sub bent denoted by a reference numeral 10A formed on the region between the screen bent 10 and the reference line, is added to the construction of the related art including the neck part 11, the screen bent part 10, and the extension part 13 for connecting the neck part 11 with the screen bent part 10. Additionally, a section part 13A for connecting the screen sub bent 10A with the screen bent 10, is provided.

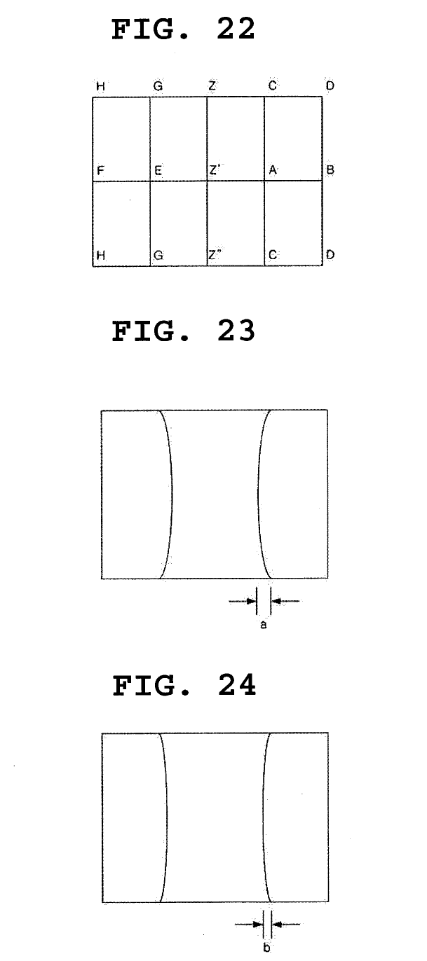

FIG. 22 is an exemplary view explaining screen region influenced by magnetic field of the deflection coil realized in FIG. 21. The function for each element of the deflection coil of the present invention will be described in the following.

First of all, the function for the section part 13A for connecting the screen sub bent 10A with the screen bent 10 will be described.

The section part positioned on the region denoted by a reference numeral B in FIG. 21, has an influence of magnetic field on the region denoted by a reference numeral H in FIG. 22 when seen from the side of the screen as shown in FIG. 22.

Therefore, in FIG. 22, for the left side with respect to a reference numeral Z-Z′-Z″, magnetic field is changed such that EF<GH and EG<FH under influence of the section part 13A positioned on the region denoted by the reference numeral B in FIG. 21.

As the section part 13A is provided in right and left symmetric manner as shown in FIG. 21, just like that magnetic field is affected to the left with respect to Z-Z′-Z″ due to the section part 13A and EF<GH and EG<FH are formed, so magnetic field is also affected to the right due to the section part 13A, whereby region D is partially affected by magnetic field and resultantly AB<CD, AC<BD are formed.

The screen bent denoted by a reference numeral 10A in FIG. 21 does not have influence of magnetic field on region EG and region AC with respect to Z-Z′-Z″, but reduces region FH and region BD.

Therefore, as shown in FIG. 21, in case that the deflection coil adopted to the deflection yoke having function of self correction of inner pin distortion of the present invention, is applied, for the right side with respect to Z-Z′-Z″, influence of deflection magnetic field is like AB<CD, AC=BD, and for the left side with respect to Z-Z′-Z″, influence of deflection magnetic field is like EF<GH, EG=FH as shown in FIG. 22.

How influence of such deflection magnetic field is represented on the actual screen, will be described with reference to FIG. 23 through FIG. 25.

FIG. 23 is an exemplary view showing degree of inner pin phenomenon generated in case that elements denoted by reference numerals 10A and 13A are all missing in construction shown in FIG. 21, i.e., in case that the deflection coil mounted on the deflection yoke of the related art is used. At the moment, the degree of the generated inner pin distortion phenomenon is represented by ‘a’ in FIG. 23.

FIG. 24 is an exemplary view showing degree of inner pin phenomenon generated in case that the deflection coil, shown in FIG. 21, provided to the deflection yoke having function of self correction of inner pin distortion, is used against inner pin phenomenon of the foregoing.

As influence of magnetic field on the central region of the screen reduces, inner pin distortion phenomenon is suppressed as shown in FIG. 24. At the moment, the degree of the generated inner pin distortion phenomenon is represented by ‘b’ in FIG. 24.

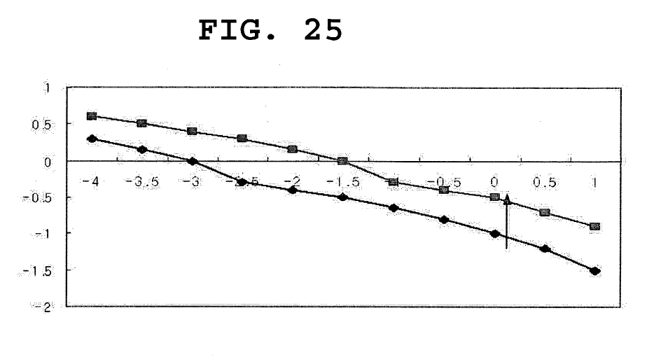

FIG. 25 is a graph showing experimental measurements for difference in degrees of inner pin distortions generated for the case that the deflection yoke having function of self correction of inner pin distortion of the present invention is not used as shown in FIG. 23, and for the case that the present invention is applied as shown in FIG. 24.

In FIG. 25, the graph formed by connection of points marked by ‘♦’ represents degree of inner pin distortion phenomenon in case that the deflection coil of the related art is used, while the graph formed by connection of points marked by ‘&Rectversolid;’ represents degree of inner pin distortion phenomenon in case that the deflection coil adopted to the deflection yoke having function of self correction of inner pin distortion of the present invention, is used. Here, X axis direction represents degree of NS distortion, and Y axis direction represents degree of inner pin distortion, in which unit of ‘mm’ is used for each direction.

As shown in FIG. 25, in case that the deflection coil of the present invention is applied, it is observed the inner pin distortion is improved as much as about 0.5 mm experimentally when NS is ‘zero’ compared to the case that the deflection coil of the related art is used.

Therefore, effect that region ZC is reduced, is achieved by suppressing inner pin phenomenon using the deflection coil of the present invention having the construction shown in FIG. 21 and by making region AB and region CD in FIG. 22 equal using a pincushion circuit provided to the CRT itself, for adjusting vertical deflection force.

As Z′A<ZC in FIG. 22 according to inner pin phenomenon, if ZC gets reduced, then Z′A=ZC, and resultantly inner pin phenomenon is improved.

The deflection yoke having function of self correction of inner pin distortion of the present invention does not require an additional circuit in order to suppress inner pincushion phenomenon on the screen as was in the related art. Therefore, reduction in production costs is accomplished and power dissipation is reduced, for the additional circuit for suppressing pincushion is not used.

Also, in the related art, it was difficult to maintain stability in distribution and characteristics of the inner pin as distribution generation gets large due to wiring of the coils. But according to the present invention, such weak point could be resolved.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A deflection yoke having function of self correction of inner pin distortion, comprising:
a coil separator on which a printed circuit board;
deflection coils mounted on inner and outer peripheries of the coil separator, respectively, and divided into a neck part, a screen bent part, and an extension part connecting the neck part and the screen bent part, for deflecting an electron beam of the CRT by generating a predetermined magnetic field;
a ferrite core mounted on an outer periphery of the coil separator, for strengthening the magnetic field of the deflection coils; and
more than one screen sub bent formed between the screen bent of the deflection coil and a reference line of the deflection yoke, for improving inner pin distortion of the screen.

2. The deflection yoke according to claim 1, wherein there exists a contact surface of the screen sub bent and the screen bent.

3. A deflection yoke having function of self correction of inner pin distortion, comprising:
a coil separator on which a printed circuit board;
deflection coils mounted on inner and outer peripheries of the coil separator, respectively, and divided into a neck part, a screen bent part, and an extension part connecting the neck part and the screen bent part, for deflecting an electron beam of the CRT by generating a predetermined magnetic field;
a ferrite core mounted on an outer periphery of the coil separator, for strengthening the magnetic field of the deflection coils;
more than one screen sub bent formed between the screen bent of the deflection coil and a reference line of the deflection yoke, for improving inner pin distortion of the screen; and
a section part symmetrically formed by connection of the screen sub bent and the screen bent of the deflection coil, for improving inner pin distortion of the screen together with the screen sub bent.

4. The deflection yoke according to claim 3, wherein there exists a contact surface of the screen sub bent and the screen bent.
